(19) United States
(12) Patent Application Publication
(10) Pub. No.: US 2007/0041742 A1
(43) Pub. Date: Feb. 22, 2007

(54) Image forming apparatus and fixing apparatus thereof

(75) Inventor: Min-gyu Kim, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd.

(21) Appl. No.: 11/450,365

(22) Filed: Jun. 12, 2006

(30) Foreign Application Priority Data
Aug. 16, 2005 (KR) 2005-74809

(51) Int. Cl. G03G 15/20

(52) U.S. Cl. 399/69; 399/70

(57) ABSTRACT

An image forming apparatus includes a heating roller part to fix developer to a printing medium, a heating part to heat the heating roller part, a power supplying part to supply electric power to the heating part, and a controlling part to control the heating roller part to have a predetermined fixing temperature in a predetermined operation mode and to have a temperature that is less than the predetermined fixing temperature but not less than a predetermined power saving temperature in a predetermined power saving mode.

### CROSS-REFERENCE TO RELATED APPLICATIONS

This application claims priority under 35 U.S.C. §119(a) from Korean Patent Application No. 2005-0074809, filed on Aug. 16, 2005, in the Korean Intellectual Property Office, the disclosure of which is incorporated herein by reference in its entirety.

### BACKGROUND OF THE INVENTION

1. Field of the Invention

The present general inventive concept relates to an image forming apparatus and a fixing apparatus thereof, and more particularly, to an image forming apparatus and a fixing apparatus thereof that is capable of reducing time required to fix developer.

2. Description of the Related Art

Generally, an image forming method for an image forming apparatus includes an electrophotographic method in which an image is developed by applying developer to an electrostatic latent image formed on a photosensitive element by a potential difference, and the developed image is transferred to a printing paper to form a printed image, an inkjet method in which an image is formed by discharging ink onto a printing paper through a plurality of inkjet nozzles, a dyes-sublimation method in which an image is formed by selectively heating an ink ribbon contacting a printing paper, etc.

The electrophotographic method is widely adopted for use with an image forming apparatus because of high printing speed, high resolution, and low cost.

An electrophotographic image forming apparatus comprises a paper feeding part, an LSU (laser scanning unit), a developing part, a fixing part, and a discharging part. The paper feeding part supplies a printing paper to the developing part, the LSU scans an input image using a laser, and then the developing part selectively applies developer onto the printing paper to form a printed image. The fixing part fixes the applied developer onto the printing paper by applying heat and pressure. The discharging part receives the printing paper having the fixed developer from the developing part and discharges the printing paper externally.

The developing part comprises a photosensitive element, a developing roller, and a fixing roller. The LSU scans the laser onto the photosensitive element to form an electrostatic latent image, the developing roller develops the latent image by supplying developer to the latent image, and then the fixing roller fixes the developer after the developed image, formed on the photosensitive element, is applied (or transferred) to the printing paper.

The fixing part comprises a heating roller and a pressing roller, which are engaged with each other with the printing paper therebetween. The heating roller heats the printing paper and the pressing roller presses the printing paper against the heating roller. The developer applied to the printing paper by the developing part is pressed and fixed to the printing paper by heat from the heating roller and pressure from the pressing roller.

FIG. 1 is a schematic view illustrating a fixing part 101 of a conventional image forming apparatus. As illustrated in FIG. 1, the fixing part 101 comprises a heating roller part 110 and a pressing roller part (not illustrated). The heating roller part 110 and the pressing roller part are engaged with each other with a printing paper therebetween. The heating roller part 110 fixes developer to the printing paper in cooperation with the pressing roller.

A heating part 120 is disposed in the heating roller part 110 to heat the heating roller part 110. A power supplying part 130 supplies electric power to the heating roller part 110. A controlling part 140 controls the power supplying part 130 to supply power to the heating part 120 to heat the heating roller part 110, so that the heating roller part 110 can maintain a predetermined fixing temperature to fix the developer.

A thermistor (not illustrated) and a thermostat (not illustrated) may be provided to control a heating temperature of the heating roller part 110. The thermistor is used to detect the heating temperature of the heating roller part 110 to maintain the predetermined fixing temperature of the heating roller part 110, and the thermostat is used to cut off the power supplied from the power supplying part 130 to prevent damaging of the apparatus caused when the heating roller part 110 is overheated.

The controlling part 140 changes power supply modes of the power supplying part 130 according to image forming processes of the image forming apparatus. In an operation mode in which the image forming apparatus performs or is ready to perform an image forming process, the controlling part 140 controls the power supplying part 130 to supply power to the heating roller part 110 to maintain the predetermined fixing temperature. In a power saving mode in which the image forming apparatus does not perform the image forming process over a predetermined period of time, the controlling part 140 cuts off the supply of power from the power supplying part 130 to prevent unnecessary power consumption.

As described above, according to the above conventional image forming apparatus, the controller 140 cuts off the supply of power from the power supplying part 130 to the heating part 120 in the power saving mode so that the temperature of the heating roller part 110 may be lowered to a normal temperature (e.g., a temperature near or at room temperature). However, when the conventional image forming apparatus is changed from the power saving mode to the operation mode to perform the image forming process, a considerable amount of time is required to heat the heating roller part 110 to have the fixing temperature. Accordingly, fixing of the developer may be delayed.

### SUMMARY OF THE INVENTION

The present general inventive concept provides an image forming apparatus and a fixing apparatus therefor which is capable of reducing time required to fix developer.

Additional aspects and/or advantages of the present general inventive concept will be set forth in part in the description which follows and, in part, will be obvious from the description, or may be learned by practice of the present invention.

The foregoing and/or other aspects and utilities of the present general inventive concept may be achieved by providing an image forming apparatus comprising a heating roller part to fix developer to a printing medium, a heating part to heat the heating roller part, a power supplying part to supply electric power to the heating part, and a controlling part to control the heating roller part to have a predetermined fixing temperature in a predetermined operation mode and to have a temperature that is less than the predetermined fixing temperature but not less than a predetermined power saving temperature in a predetermined power saving mode.

The heating part may comprise a main heater and a sub heater, the power supplying part may comprise a main power part to supply electric power to the main heater and a sub power part to supply electric power to the sub heater, and the controlling part may cut off the electric power supplied by the main power part and enables the electric power supplied by the sub power part to heat the sub heater so that the heating roller part has the temperature that is less than the predetermined fixing temperature but not less than the predetermined power saving temperature in the predetermined power saving mode.

The image forming apparatus may further comprise a host to supply print image information and an interface part to communicate with the host. The host may comprise a host power part, the interface part may comprise a universal serial bus to transmit electric power, and the host power part may supply the electric power to the sub heater through the universal serial bus.

The controlling part can control the main heater and the sub heater to both heat the heating roller part in cooperation with each other in the predetermined operation mode.

The predetermined power saving mode can begin when the print image information has not been supplied by the host over a predetermined period of time.

The foregoing and/or other aspects and utilities of the present general inventive concept may also be achieved by providing a fixing apparatus comprising a heating roller part to fix developer to a printing medium, a heating part to heat the heating roller part, a power supplying part to supply electric power to the heating part, and a controlling part to control the heating roller part to have a predetermined fixing temperature in a predetermined operation mode and to have a temperature that is less than the predetermined fixing temperature but not less than a predetermined power saving temperature in a predetermined power saving mode.

The foregoing and/or other aspects and utilities of the present general inventive concept may also be achieved by providing a fixing unit useable with an image forming apparatus, comprising a heating unit to apply heat to a developed image, at least one heating device to heat the heating unit and a controlling unit to control the at least one heating device to heat the heating unit to a predetermined fixing temperature during an operation mode and to heat the heating unit to a temperature that is less than the predetermined fixing temperature but greater than or equal to a predetermined power saving temperature during a power save mode.

The control unit can control the at least one heating device by regulating an amount of power supplied to the at least one heating device. The at least one heating device can comprise first and second heating devices. The controller can control the first heating device to heat the heating unit to a predetermined fixing temperature during an operation mode, and the controller can control the second heating device to heat the heating unit to a temperature that is less than the predetermined fixing temperature but greater than or equal to a predetermined power saving temperature during a power save mode.

The fixing unit can further comprise a first power supply device to supply power to the first heating device, and a second power supply device to supply power to the second heating device. The first and second heating devices can comprise at least one of heat generating resistance devices that heat the heating unit using conduction and halogen lamps that heat the heating unit using radiation. The controlling unit can control the first and second heating devices to heat the heating unit to the predetermined fixing temperature during the operation mode. The predetermined power saving temperature can be determined based on at least one of power consumption and a time needed to heat the heating unit to the fixing temperature.

The foregoing and/or other aspects and utilities of the present general inventive concept may also be achieved by providing an image forming apparatus, comprising a fixing unit to fix a developed image comprising a heating unit to apply heat to the developed image and first and second heating devices to each heat the heating unit and a controlling unit to control predetermined amounts of power supplied to the first and second heating devices.

The image forming apparatus can further comprise a main power supply unit to supply power to the first heating device, and an interface unit to communicate with an external host apparatus having a secondary power supply unit to supply power to the second heating device through the interface unit.

The foregoing and/or other aspects and utilities of the present general inventive concept may also be achieved by providing a method of fixing a developed image using a heating unit of an image forming apparatus, the method comprising controlling the heating unit to have a predetermined fixing temperature during an operation mode of the image forming apparatus, and controlling the heating unit to have a temperature that is less than the predetermined fixing temperature but greater than or equal to a predetermined power saving temperature during a power save mode of the image forming apparatus.

The method may further include controlling a first heating device of the heating unit to heat the heating unit to the predetermined fixing temperature during the operation mode, and controlling a second heating device of the heating unit to heat the heating unit to the temperature that is less than the predetermined fixing temperature but greater than or equal to the predetermined power saving temperature during the power save mode. The method may further include controlling the first and second heating devices of the heating unit to heat the heating unit to the predetermined fixing temperature during the operation mode. The method may further include controlling the image forming apparatus to be in the operation mode for a first predetermined period of time when the image forming apparatus receives print information, and controlling unit the image forming apparatus to be in the power save mode when the image forming apparatus has not received printing information for a second predetermined period of time. The predetermined power saving temperature can be determined based on at least one of power consumption and a time needed to heat the heating unit to the fixing temperature.

### BRIEF DESCRIPTION OF THE DRAWINGS

The above and/or other aspects and advantages of the present general inventive concept will become apparent and more readily appreciated from the following description of the embodiments, taken in conjunction with the accompanying drawings of which:

FIG. 1 is a schematic view illustrating a fixing part of a conventional image forming apparatus; and

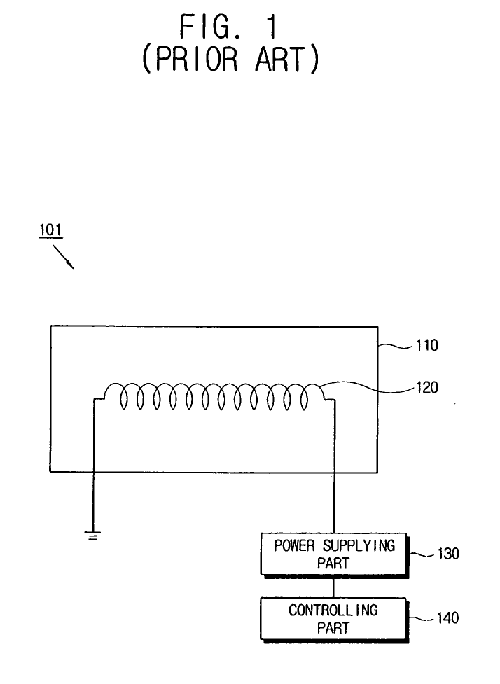

FIG. 2 is a schematic view illustrating a fixing part of an image forming apparatus according to embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

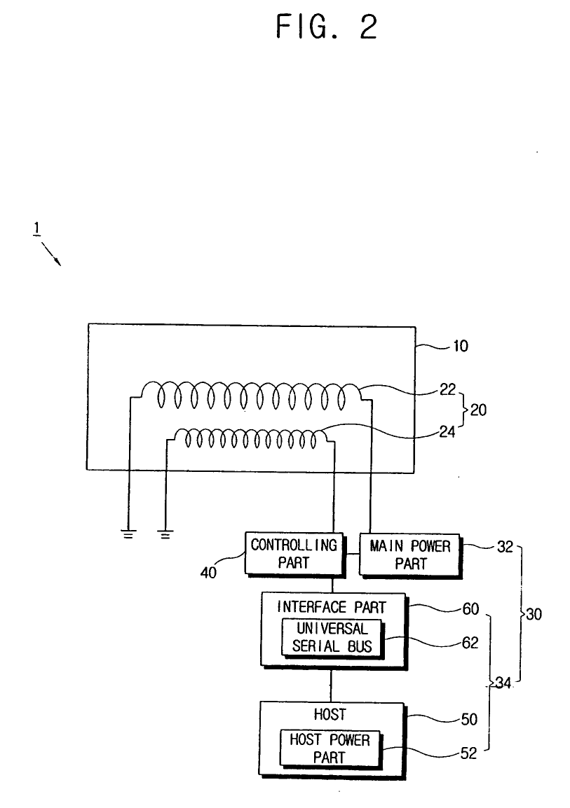

FIG. 2 illustrates a schematic view of a fixing part 1 of an image forming apparatus according to embodiments of the present general inventive concept. The image forming apparatus comprises a developing part (not illustrated) and the fixing part 1 illustrated in FIG. 2. The developing part applies developer onto a printing medium, such as, for example, paper, using a potential difference to form a print image on the printing medium. Then, the fixing part 1 receives the printing medium having the applied developer thereon and fixes the developer on the printing medium.

The fixing part 1 can comprise a heating roller part 10 and a pressing roller part (not illustrated). The heating roller part 10 and the pressing roller part can be engaged with each other with the printing medium therebetween, and each can rotate to apply heat and pressure to the printing medium. The pressing roller part can be supported by an elastic member (not illustrated) to elastically press the pressing roller part toward the heating roller part 10.

The heating part 20 heats the heating roller part 10. The heating part 20 can comprise a main heater 22 and a sub heater 24. The main heater 22 and the sub heater 24 may be disposed in a roller sleeve (not illustrated) of the heating roller part 10. The main heater 22 and the sub heater 24 may comprise heating units, such as heat generating resistance devices that heat the heating roller part 10 by conduction or halogen lamps that heat the heating roller part 10 by radiation.

A power supplying part 30 can supply electric power to the heating part 20. The power supplying part 30 can comprise a main power part 32 to supply electric power to the main heater 22, and a sub power part 34 to supply electric power to the sub heater 24. The main heater 22 can receive the electric power supplied by the main power part 32 to heat the heating roller part 10, and the sub heater 24 can receive the electric power supplied by the sub power part 34 to heat the heating roller part 10.

A host 50 can supply print image information to the image forming apparatus. The host 50 can comprise a host power part 52. The host 50 may comprise a personal computer, a notebook computer, or other units capable of processing information. The host power part 52 may comprise a conventional power supplying unit to supply electric power to various devices in the host 50 for the host 50 to perform a predetermined information process.

The image forming apparatus can further comprise an interface part 60 to communicate with the host 50. The interface part 60 can comprise a universal serial bus (USB) 62 through which predetermined electric power may be communicated. The interface part 60 may also comprise a terminal part (not illustrated) and a circuit board (not illustrated), which can be connected to the USB 62. The USB 62 can connect the host 50 with the image forming apparatus to enable communication of information therebetween. Also, the USB 62 may transmit electric power having a predetermined voltage from the host 50 to the image forming apparatus. The voltage of the electric power supplied through the USB 62 may be, for example, 5V. The sub heater 24 can receive the electric power from the host power part 52 through the USB 62. Thus, the sub power part 34 may comprise the host power part 52, which is installed in the host 50, to transmit the electric power through the USB 62.

A controlling part 40 can control the heating roller part 10 to have a predetermined fixing temperature in a predetermined operation mode and to have a temperature that is less than the predetermined fixing temperature but not less than a predetermined power saving temperature in a predetermined power saving mode. In the power saving mode, the controlling part 40 can cut off the power supplied from the main power part 32 and can allow the power supplied from the sub power part 34 to heat the sub heater 24 so that the heating roller part 10 may have a temperature that is less than the predetermined fixing temperature but not less than the predetermined power saving temperature.

The controlling part 40 may control the power supplied from the power supplying part 30 in a plurality of modes, including the operation mode and the power saving mode, to minimize power consumption of the image forming apparatus. The operation mode may continue when the image forming apparatus is performing the image forming process or is ready for performing the image forming process. The controlling part 40 may control the image forming apparatus to be in the operation mode for a predetermined time after the image forming apparatus has received the print image information. The power saving mode may begin when the image forming apparatus does not perform the image forming process for a period of time. The controlling part 40 may control the image forming apparatus to be in the power saving mode when the print image information has not been supplied to the image forming apparatus over a predetermined period of time.

In the operation mode, the controlling part 40 can control the power supplying part 30 so that the heating roller part 10 can maintain the predetermined fixing temperature to perform a fixing process. Accordingly, the power supplying part 30 can supply electric power to the heating part 20 so that the heating part 20 continuously heats the heating roller part 10. In the operation mode, the controlling part 40 can cut off the power supplied from the sub power part 34 and can allow the power to be supplied from the main power part 32, so that only the main heater 22 heats the heating roller part 10.

On the other hand, the controlling part 40 may control the main heater 22 and the sub heater 24 to heat the heating roller part 10 in cooperation with each other in the operation mode. In this case, the controlling part 40 may allow transmission of electric power from both of the main power part 32 and the sub power part 34 in the operation mode. By heating the heating roller part 10 using both the main heater 22 and the sub heater 24, a rate in which the temperature of the heating roller part 10 is raised can be increased and a fine control of the temperature of the heating roller part 10 can be achieved. In particular, when the power supply mode changes from the power saving mode to the operation mode, heating the heating roller part 10 using both of the main heater 22 and the sub heater 24 can reduce a time required to raise the temperature of the heating roller part 10 to the fixing temperature.

In the power saving mode, the controlling part 40 can control the heating roller part 10 to have a temperature that is not less than the predetermined power saving temperature. In the power saving mode, the controlling part 40 can cut off the power supplied from the main power part 32 and can allow the host power part 52 of the host 50 to supply electric power to the sub heater 24 through the USB 62. The temperature of the heating roller part 10 is not lowered to a normal temperature (e.g., a temperature at or near room temperature), but is maintained at the predetermined power saving temperature. Accordingly, when the power supply mode changes from the power saving mode to the operation mode, the time required to heat the heating roller part 10 to have the fixing temperature can be minimized. The predetermined power saving temperature of the heating roller part 10 in the power saving mode may be determined based on, for example, a power consumption and/or a time to raise the temperature of the heating roller 10 to the fixing temperature.

In the image forming apparatus described above, because the heating roller part 10 can maintain the predetermined power saving temperature by receiving electric power from the host 50 through the USB 62 in the predetermined power saving mode, the controlling part 40 may control the heating roller part 10 to have the power saving temperature even if all electric power supplied from the image forming apparatus, including that of the main power part 32, is cut off. Accordingly, the power consumption of the image forming apparatus can be minimized during the power saving mode.

In the above embodiment, the electric power of the host power part 52 supplied to the sub heater 24 through the USB 62 is provided as the sub power part 34 as illustrated in FIG. 2, but the sub power part 34 is not so limited. For example, a power supply part entirely disposed in the image forming apparatus may be provided as the sub power part 34. In addition, the sub heater 24 may be supplied with electric power from the main power part 32. In this case, the controlling part 40 can control the main power part 32 to supply the sub heater 24 with electric power that is less than the electric power supplied to the main heater 22.

In the above embodiments, the heating part 20 may comprise the main heater 22 and the sub heater 24, and the power supplying part 30 may comprise the main power part 32 and the sub power part 34. However, the heating part 20 and the power supplying part 30 may together have a single heater and a single power part. In this case, in the power saving mode, the controlling part 40 can control the power supplying part 30 to supply the heating part 20 with electric power that is less than the electric power supplied in the operation mode.

As illustrated in FIG. 2, the fixing apparatus 1 can comprise the heating roller part 10 to fix the developer to the printing medium, the heating part 20 to heat the heating roller part 10, the power supplying part 30 to supply electric power to the heating part 20, and the controlling part 40 to control the heating roller part 10 to have the predetermined fixing temperature in the predetermined operation mode and to have a temperature that is less than the predetermined fixing temperature but not less than the predetermined power saving temperature in the predetermined power saving mode.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a heating roller part to fix developer to a printing medium;
a heating part to heat the heating roller part;
a power supplying part to supply electric power to the heating part; and
a controlling part to control the heating roller part to have a predetermined fixing temperature in a predetermined operation mode and to have a temperature that is less than the predetermined fixing temperature but not less than a predetermined power saving temperature in a predetermined power saving mode.

2. The image forming apparatus according to claim 1, wherein:
the heating part comprises a main heater and a sub heater;
the power supplying part comprises a main power part to supply electric power to the main heater and a sub power part to supply electric power to the sub heater; and
the controlling part cuts off the electric power supplied by the main power part and enables the electric power supplied by the sub power part to heat the sub heater so that the heating roller part has the temperature that is less than the predetermined fixing temperature but not less than the predetermined power saving temperature in the predetermined power saving mode.

3. The image forming apparatus according to claim 2, further comprising:
a host to supply print image information; and
an interface part to communicate with the host.

4. The image forming apparatus according to claim 2, wherein the controlling part controls the main heater and the sub heater to both heat the heating roller part in cooperation with each other in the predetermined operation mode.

5. The image forming apparatus according to claim 3, wherein the predetermined power saving mode begins when the print image information has not been supplied by the host over a predetermined period of time.

6. The image forming apparatus according to claim 4, wherein the predetermined power saving mode begins when the print image information has not been supplied by the host over a predetermined period of time.

7. A fixing apparatus, comprising:
a heating roller part to fix developer to a printing medium;
a heating part to heat the heating roller part;
a power supplying part to supply electric power to the heating part; and
a controlling part to control the heating roller part to have a predetermined fixing temperature in a predetermined operation mode and to have a temperature that is less than the predetermined fixing temperature but not less than a predetermined power saving temperature in a predetermined power saving mode.

8. The image forming apparatus according to claim 3, wherein:
the host comprises a host power part;
the interface part comprises a universal serial bus to transmit electric power; and
the host power part supplies the electric power to the sub heater through the universal serial bus.

9. A fixing unit useable with an image forming apparatus, comprising:
a heating unit to apply heat to a developed image;
at least one heating device to heat the heating unit; and
a controlling unit to control the at least one heating device to heat the heating unit to a predetermined fixing temperature during an operation mode and to heat the heating unit to a temperature that is less than the predetermined fixing temperature but greater than or equal to a predetermined power saving temperature during a power save mode.

10. The fixing unit according to claim 9, wherein the control unit controls the at least one heating device by regulating an amount of power supplied to the at least one heating device.

11. The fixing unit according to claim 9, wherein the at least one heating device comprises first and second heating devices.

12. The fixing unit according to claim 11, wherein:
the controller controls the first heating device to heat the heating unit to a predetermined fixing temperature during an operation mode; and
the controller controls the second heating device to heat the heating unit to a temperature that is less than the predetermined fixing temperature but greater than or equal to a predetermined power saving temperature during a power save mode.

13. The fixing unit according to claim 11, further comprising:
a first power supply device to supply power to the first heating device; and
a second power supply device to supply power to the second heating device.

14. The fixing unit according to claim 11, wherein the first and second heating devices comprise at least one of heat generating resistance devices that heat the heating unit using conduction and halogen lamps that heat the heating unit using radiation.

15. The fixing unit according to claim 11, wherein the controlling unit controls the first and second heating devices to heat the heating unit to the predetermined fixing temperature during the operation mode.

16. The fixing unit according to claim 9, wherein the predetermined power saving temperature is determined based on at least one of power consumption and a time needed to heat the heating unit to the fixing temperature.

17. An image forming apparatus, comprising:
a fixing unit to fix a developed image, comprising:
a heating unit to apply heat to the developed image, and
first and second heating devices to each heat the heating unit; and
a controlling unit to control predetermined amounts of power supplied to the first and second heating devices.

18. The image forming apparatus according to claim 17, further comprising:
a main power supply unit to supply power to the first heating device; and
an interface unit to communicate with an external host apparatus having a secondary power supply unit to supply power to the second heating device through the interface unit.

19. A method of fixing a developed image using a heating unit of an image forming apparatus, the method comprising:
controlling the heating unit to have a predetermined fixing temperature during an operation mode of the image forming apparatus; and
controlling the heating unit to have a temperature that is less than the predetermined fixing temperature but greater than or equal to a predetermined power saving temperature during a power save mode of the image forming apparatus.

20. The method according to claim 19, further comprising:
controlling a first heating device of the heating unit to heat the heating unit to the predetermined fixing temperature during the operation mode; and
controlling a second heating device of the heating unit to heat the heating unit to the temperature that is less than the predetermined fixing temperature but greater than or equal to the predetermined power saving temperature during the power save mode.

21. The method according to claim 20, further comprising:
controlling the first and second heating devices of the heating unit to heat the heating unit to the predetermined fixing temperature during the operation mode.

22. The method according to claim 19, further comprising:
controlling the image forming apparatus to be in the operation mode for a first predetermined period of time when the image forming apparatus receives print information; and
controlling unit the image forming apparatus to be in the power save mode when the image forming apparatus has not received printing information for a second predetermined period of time.

23. The method according to claim 19, wherein the predetermined power saving temperature is determined based on at least one of power consumption and a time needed to heat the heating unit to the fixing temperature.
